(19) United States
(12) Patent Application Publication
(10) Pub. No.: US 2008/0168908 A1
(43) Pub. Date: Jul. 17, 2008

(54) SILICONE WARMER

(76) Inventors: Mathieu Lion, Paris (FR); Lucas Bignon, Cachan (FR)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 12/013,716

(22) Filed: Jan. 14, 2008

Related U.S. Application Data
(60) Provisional application No. 60/884,709, filed on Jan. 12, 2007.

(51) Int. Cl. A47J 36/04

(52) U.S. Cl. 99/413

(57) ABSTRACT

A steamer for warming food includes a silicone base and a silicone cover. The silicone base has a bottom surface, a side surface and a rim. The bottom surface is designed to receive food to be heated, and the side surface extends upwardly from a perimeter of the bottom surface to the rim. The silicone cover is designed to be disposed on the base and sized to fully cover the rim. The cover provides a frictionless coupling with the base, but produces a hermetic seal with the base during heating of food contained within the steamer.

### REFERENCE TO RELATED APPLICATION

This application claims priority to U.S. Provisional Patent Application No. 60/884,709, filed Jan. 12, 2007, the disclosure of which is incorporated herein by reference.

### BACKGROUND OF THE INVENTION

1. Field of the Invention

This invention relates to a silicone warmer, also called a warmer steamer, and, more particularly, to a silicone warmer steamer that is designed to produce a hermetic seal between the warmer steamer's cover and base during heating to provide desirable cooking conditions for the food within the warmer steamer.

2. Description of the Related Art

Silicone and other types of flexible bakeware recently have become popular. Various exemplary silicone bakeware are disclosed in the following documents: U.S. Patent Publication No. 2005/0211101; U.S. Patent Publication No. 2006/0045949; U.S. Patent Publication No. 2001/0043977; U.S. Patent Publication No. 2005/0247212; U.S. Patent Publication No. 2002/017027; U.S. Pat. No. 6,197,359; French Patent Publication FR2747885A1; and European Patent Publication EP1598401A1. While silicone bakeware has become well know, other distinct cooking uses for silicone remain available, as described herein.

### SUMMARY OF THE INVENTION

In accordance with the present invention, a steamer for warming food comprises a silicone base and a silicone cover. The silicone base has a bottom surface, a side surface and a rim. The bottom surface is designed to receive food to be heated, and the side surface extends upwardly from a perimeter of the bottom surface to the rim. The silicone cover is ventless (i.e., has no holes) and is designed to be disposed on the base and sized to fully cover the rim, and to provide a frictionless coupling with the base.

As an aspect of the invention, during use of the warmer steamer (i.e., during heating), there is an airtight coupling between the cover and the base.

As another aspect of the invention, the side surface extends completely around the bottom surface.

As a further aspect of the invention, the cover is light weight and flexible.

As an additional aspect, the base includes a pair of rigid gripping ends.

As another aspect, the rigid gripping ends include a material having a thermal expansion characteristic that is substantially less than a thermal expansion characteristic of the cover.

As a further aspect of the invention, the cover is designed to produce a hermetic seal with the base when the steamer containing food on the bottom surface of the base is heated and then removed from the heating source.

As an additional aspect of the invention, the cover is designed to be drawn downward toward the bottom surface of the base when the steamer containing food on the bottom surface of the base is heated.

As yet a further aspect of the invention, the steamer is designed to be utilized (e.g., within traditional or Microwave ovens) to temperatures above 150 degrees Celsius.

As yet an additional aspect of the invention, neither the base nor the cover includes vents.

As still yet a further aspect of the invention, the cover includes an underside surface, and the underside surface includes a plurality of ridges having a star-shaped arrangement adapted to add rigidity to the cover and to channel liquids onto food disposed within the warmer steamer when the cover is provided in a concave position.

As another aspect, the cover is adapted for heat expansion to create a hermetic fit with the base.

Various other objects, advantages and features of the present invention will become readily apparent to those of ordinary skill in the art, and the novel features will be particularly pointed out in the appended claims.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a schematic illustration showing a perspective view of the warmer steamer of the present invention in a closed position;

FIG. 2 is a schematic illustration showing a side view of the warmer steamer of the present invention;

FIG. 3 is a schematic illustration showing a front view of the warmer steamer of the present invention;

FIG. 4 is a schematic illustration showing a top view of the warmer steamer of the present invention;

FIG. 5 is a schematic illustration showing a bottom view of the warmer steamer of the present invention;

FIG. 6 is a schematic illustration showing the warmer steamer of the present invention with the base and cover separated from one another;

FIG. 7 is a schematic illustration showing the warmer steamer during cooking;

FIG. 8 is a schematic illustration showing the warmer steamer after being removed from the oven;

FIG. 9 is a schematic illustration showing the underside of the warmer steamer's cover in accordance with the present invention; and

FIG. 10 is a schematic illustration showing a cross-section of the warmer steam of the present invention.

### DETAILED DESCRIPTION OF THE PRESENT INVENTION

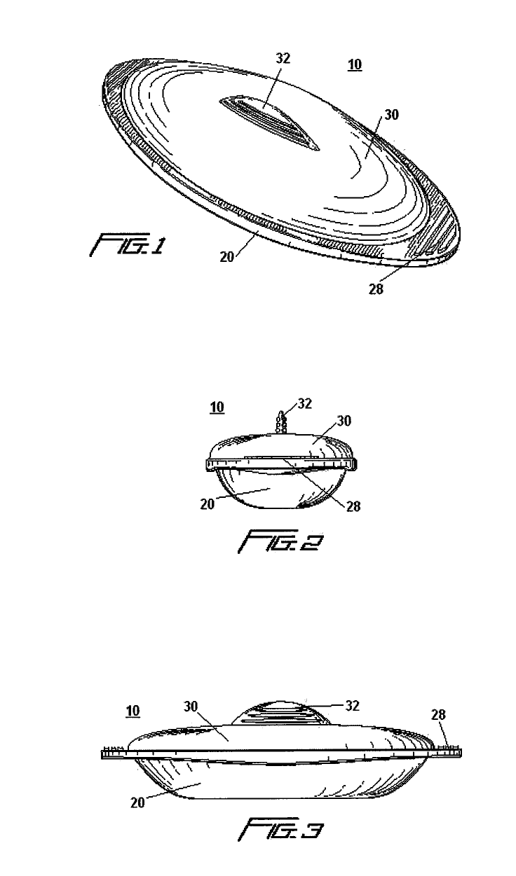

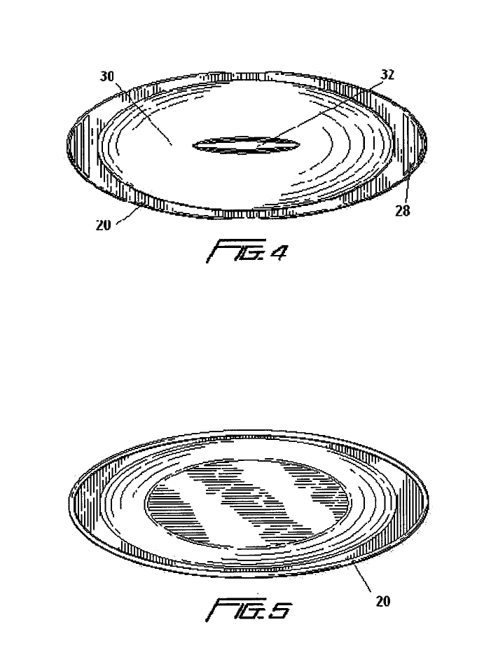

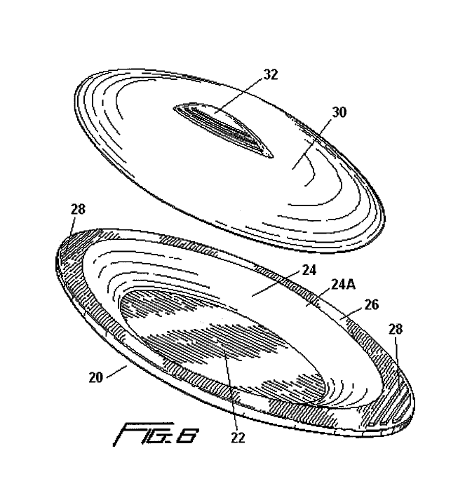

Referring to the drawings, FIGS. 1-6 schematically illustrate the general configuration and shape of silicone warmer 10 of the present invention (also called herein, for convenience, “warmer steamer”). As shown, warmer steamer 10 includes a base 20 and a cover 30 sized and configured to be disposed on base 20. Base 20 and cover 30 are made of synthetic, soft polymer material. In a preferred version, base 20 and cover 30 are made of silicone.

FIG. 1 is a perspective view showing the warmer steamer in its closed position with cover 30 disposed on base 20. FIGS. 2, 3, 4 and 5 are side, front, top and bottom views, respectively, of warmer steamer 10 of the present invention. FIG. 6 shows the warmer steamer with base 20 and cover 30 separated from one another. In addition, FIG. 10 shows a cross-section of the warmer steamer.

As best shown in FIGS. 6 and 10, base 20 includes a substantially flat interior bottom surface 22 on which food products are disposed during use of the warmer steamer of the present invention. Bottom surface 22 (or simply “bottom 22”) may be completely flat or contain ridges, slots, compartments or other structure. A sloped surface 24 extends from a perimeter of bottom 22 to a rim 26 of base 20.

Rim 26 includes a pair of gripping ends 28 (or “grips” 28), which are also called handles herein. In a preferred version, each grip 28 is relatively rigid to enable for easier handling during use of the warmer steamer of the present invention. Preferably, grips 28 include plastic inserts. Providing rigid grips (or handles) is disclosed in U.S. Patent Publication No. US2005/0056642, owned by the assignee of the present invention, and incorporated herein by reference.

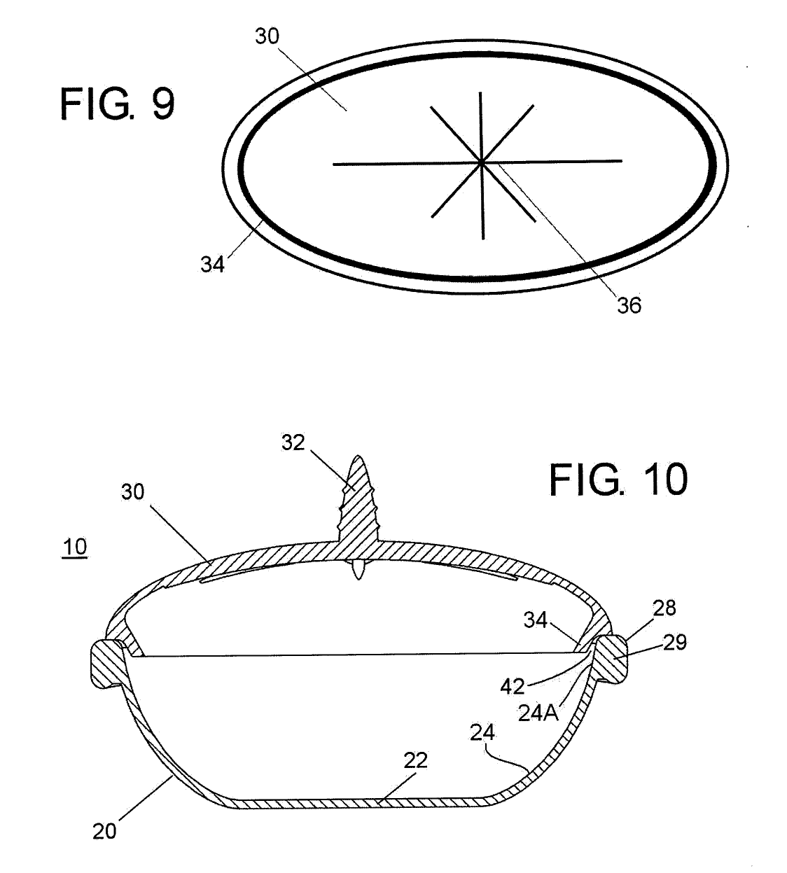

Cover 30 is ventless, that is, it does not contain any holes, and is sized and shaped so that it may be placed on base 20 in the manner shown in FIG. 1. Cover 30 is light weight and flexible and, as mentioned above, preferably is made of silicone. Cover 30 includes a lip 34 extending from its underside, shown in FIGS. 9 and 10, that is closely aligned to the uppermost surface 24A of the base's sloped surface 24 (see FIGS. 6 and 10). Cover 30 includes a handle 32 to allow for the easy removal of cover 30 from base 20 during use.

As described herein, the warmer steamer of the present invention preferably is made of silicone, where base 20 of the warmer steamer includes rigid handles 28 that are made of plastic. As is known, silicone has a thermal expansion of between 3% and 5% during cooking whereas the thermal expansion of plastic is four (4) times less. In accordance with a particularly beneficial feature of the invention, by providing the base with rigid handles made of plastic, and plastic prevents or, at least, minimizes thermal expansion, the base retains its original size during both heating and cooling. Also, as schematically illustrated in FIG. 10, cover 30 is provided with a small clearance 42, preferably around 3.5 mm, between its outer surface on the wall side (lip 34) and the base's inner surface 24A. By providing a cover made of full silicone, a size increase of between 3% and 5% of the cover that results during typical heating operations causes the cover to perfectly fit with the base and to have a hermetic seal both before and during heating. Heating operations and use of the warmer steamer of the present invention are further discussed below.

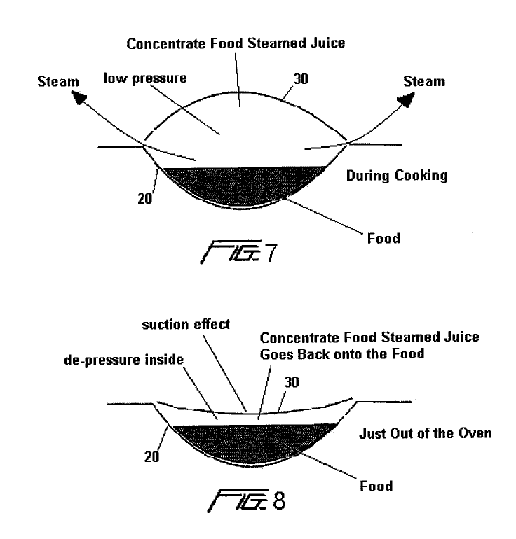

During use of warmer steamer 10 of the present invention, food to be cooked, heated or warmed is placed on bottom 22 (see FIGS. 6 and 10) of base 20 of the warmer steamer. Cover 30 is placed on base 20, and the warmer steamer is placed in a regular oven, a microwave oven or other appropriate heating apparatus. During heating/cooking of the food and/or liquids disposed within warmer steamer 10, steam is produced and, in accordance with the present invention and as schematically shown in FIG. 7, pressure inside the warmer steamer gradually increases generally up to a maximum pressure of 100 Pa or, more accurately, 100 Pa above atmospheric pressure, at which point cover 30 slightly rises (i.e., lifts off base 20) to allow some steam within the warmer steamer to escape. For example, at sea level at an ambient temperature of 0° C., atmospheric pressure is 101.325 kPa and, therefore, pressure within the warmer steamer increases during heating until it reaches a pressure of about 101.425 kPa before cover 30 sufficiently rises to allow steam to escape. After some steam escapes, the raised cover returns to its lowered and airtight position within less than a second, at which point, steam/pressure gradually builds up, repeating the process.

During and after steam release, food within the warmer steamer of the present invention continues to cook near atmospheric pressure with minimal liquid loss. When the warmer steamer is removed from the heat source (e.g., regular oven, microwave oven), steam within the warmer steamer cools at a faster rate than the food within the warmer steamer and thus changes to liquid phase, which results in a reduction in pressure creating a depression within the warmer steamer which, in turn, causes synthetic cover 30, preferably made of silicone as discussed above, to be pulled downward thus taking on the concave shape shown in FIG. 8. With such a concave shape, juices/liquids on the underside of the cover drip onto the food within base 20. With such a depression, it is well known by those of ordinary skill in the art that food fibers will stretch and open, thus allowing dripping juices to penetrate deeper into food fibers and will also tenderize the food.

As discussed above, cover 30 is sufficiently light to allow it to be lifted with a pressure or 100 pa or more. In addition, cover 30 is flexible enough so that it forms the concave shape, as previously described, when there is a heat reduction. In the preferred version, cover 30 has a thickness in the range of 1.5 mm to 4.0 mm, with a more particularly preferred thickness range of between 2 mm and 3 mm.

In accordance with the present invention, cover 30 mates to base 20 to form a hermetic seal, but without the use of resistance. That is, there is a frictionless connection between cover 30 and base 20. As a result of the frictionless connection, cover 30 easily lifts up upon the generation of sufficient pressure starting as low as 20 Pa and as high as 300 Pa (preferably, 100 Pa, as described above), within the warmer steamer during cooking/heating. In accordance with the present invention, food within the warmer steamer cooks quickly in an atmospheric temperature of generally a maximum 101 degree Celsius, thereby beneficially retaining both nutritional components and flavor. As described above, upon removal of the warmer steamer from a heat source, the shape/design of the interconnection between cover 30 and base 20 causes cover 30 to seal itself on base 20 and is drawn downward to produce the concave shape shown in FIG. 8 (also called herein as the “suction effect”). With such concave shape, liquids formed on the underside of cover 30 drip onto the food contained within base 20 and, further, advantageously result in additional absorption of the liquids by the food.

FIG. 9 shows the underside of the warmer steamer's cover 30 in accordance with the present invention. As shown, cover 30 preferably includes a set of protruding ridges 36 having a star-shaped arrangement to provide additional rigidity to cover 30 and also to direct liquids that have formed on the underside of the cover over the center of base 20, thus causing the liquids to drip onto the center of the food contained within the base.

As shown in the drawings, neither base 20 nor cover 30 includes vents that allow steam within the warmer steamer to escape. As a result of this design, steam that is produced during heating creates a “seal” (i.e., a film of water) between the contact surfaces of the base and cover. The seal that is created coupled with the fitting design maintains sufficient steam to remain inside the warmer steamer which in turn provides for suitable cooking of the food with a relatively high level of humidity, but never exceeding an internal atmospheric temperature of 101 degree Celsius as long as moisture remains in the container, a desired cooking trait. Thus, while steam is able to escape, as mentioned above, steam is prevented from escaping the warmer steamer too quickly. The seal that is created further results in the above mentioned suction effect when the warmer steamer is removed from the heat source.

The warmer steamer of the present invention, preferably made completely of silicone, can be utilized to temperatures of more than 150° C. Due to the particular material utilized, cover 30 may be removed from base 20 by hand, without getting burned (although handle 32 may remain relatively hot for a relatively short period of time). The warmer steamer of the present invention is extremely lightweight and is suitable to cook/heat a large variety of foods.

Advantageously, food may be stored in a refrigerator or freezer within the warmer steamer and then, if desired, directly placed in a regular or microwave oven to defrost, warm, heat and/or cook the food contained with the warmer steamer. Conversely, after heating of food within the warmer steamer, the warmer steamer and the heated/cooked food therein may be placed in a refrigerator or freezer for later use.

The warmer steamer of the present invention, due to its design and materials utilized, maintains the heated/cooked food hot for a relatively long period of time after removal of the warmer steamer from the heat source due to the hermetic seal that is formed between the warmer steamer's base and cover, as described herein. Thus, heat within the warmer steamer is lost at a relatively slow rate, thus maintaining the heated/cooked food at a hot temperature while making juices being absorbed and infused by the food for a longer period of time as compared to most currently available cooking devices.

Finally, although the drawings show the warmer steamer of the present invention having a generally oval shape, other configurations are possible, including but not limited to a round shape. Further, as another example, the star-shaped arrangement of the ridges on the underside of the cover may be modified in various manners, such as by providing additional ridges, curves ridges, and ridges arranged in a variation of the star-shape shown. Thus, the present invention covers other variations as would be appreciated to those of ordinary skill in the art.

Therefore, it is intended that the appended claims be interpreted as including the embodiments described herein, the alternatives mentioned above, and all equivalents thereto.

What is claimed is:

1. A steamer for warming food, comprising:
a silicone base having a bottom surface, a side surface and a rim, the bottom surface adapted to receive food to be heated, the side surface extending upwardly from a perimeter of the bottom surface to the rim; and
a ventless silicone cover adapted to be disposed on the base and sized to fully cover the rim and to provide a frictionless coupling with the base.

2. The steamer of claim 1, wherein the cover and based are adapted to provide an airtight coupling during a heating operation of food disposed within the steamer.

3. The steamer of claim 1, wherein the side surface extends completely around the bottom surface.

4. The steamer of claim 1, wherein the base includes a pair of rigid gripping ends.

5. The steamer of claim 4, wherein the rigid gripping ends include a material having a thermal expansion characteristic that is substantially less than a thermal expansion characteristic of the cover.

6. The steamer of claim 1, wherein the cover is adapted to produce a hermetic seal with the base when the steamer containing food on the bottom surface of the base is heated, the cover being adapted to be lifted from the base with a pressure starting at 20 Pa.

7. The steamer of claim 1, wherein the cover is adapted to be drawn downward toward the bottom surface of the base when the steamer containing food on the bottom surface of the base is heated and then removed from a heat source.

8. The steamer of claim 1, wherein the steamer is adapted to be utilized within an oven at ambient temperatures above 150 degrees Celsius.

9. The steamer of claim 1, wherein neither the base nor the cover includes vents.

10. The steamer of claim 1, wherein the cover includes an underside surface, and the underside surface includes a plurality of ridges having a star-shaped arrangement adapted to add rigidity to the cover and to channel liquids onto food disposed within the warmer steamer when the cover is provided in a concave position.

11. The steamer of claim 1, wherein the cover is adapted for heat expansion to create a hermetic fit with the base.
